(19) United States
(12) Patent Application Publication
(10) Pub. No.: US 2021/0086888 A1
(43) Pub. Date: Mar. 25, 2021

(54) ACOUSTIC BARRIER ASSEMBLY FOR USE IN A VEHICLE

(71) Applicant: Gulfstream Aerospace Corporation, Savannah, GA (US)

(72) Inventors: Nicholas Yovich, Savannah, GA (US); Mike Lucas, Savannah, GA (US); Elica Simons, Savannah, GA (US)

(73) Assignee: Gulfstream Aerospace Corporation, Savannah, GA (US)

(21) Appl. No.: 16/581,088

(22) Filed: Sep. 24, 2019

(51) Int. Cl. B64C 1/40; B60R 13/08; G10K 11/162

(52) U.S. Cl. CPC B64C 1/40; B64D 2033/0206; G10K 11/162; B60R 13/0815

(57) ABSTRACT

An acoustic barrier assembly includes a first wall that is gas impermeable. The acoustic barrier assembly further includes a second wall that is gas impermeable. The second wall is disposed opposite the first wall. The acoustic barrier assembly further includes a periphery wall coupling the first wall with the second wall in a manner that forms a pocket between the first wall and the second wall. The periphery wall is flexible, and the pocket is fluid-tight. The acoustic barrier assembly further includes a gas disposed in the pocket. The gas has a first molecular weight that is lower than a second molecular weight of air. The acoustic barrier assembly still further includes a biasing member that is disposed within the pocket. The biasing member is coupled with both the first wall and the second wall.

### TECHNICAL FIELD

The present invention relates generally to inhibiting the transmission of sound, and more particularly relates to an acoustic barrier assembly and a method of manufacturing an aircraft using an acoustic barrier assembly.

### BACKGROUND

It is desirable to obstruct and/or impede the transmission of sound from one location to another onboard a vehicle. For example, it is desirable to inhibit the sounds of the freestream air flowing over an exterior portion of an aircraft from entering the cabin of the aircraft. In another example, it is desirable to prevent sounds in one compartment of an aircraft from passing through a bulkhead and/or a door and entering into another compartment of the aircraft.

One solution entails the positioning of a mass between compartments or between adjacent locations to provide sound insulation. This approach is currently employed in many aircraft applications. A single wall mass barrier material is placed between the sound source and the desired quiet receiver space, for example. A drawback of using a single wall mass barrier to inhibit the transmission of sound is that, in some applications, in order to obtain desirable levels of sound insulation, substantial amounts of mass must be used. This is undesirable in vehicle applications because increasing the mass of the vehicle can adversely impact the performance of the vehicle.

Another solution entails separating compartments or adjacent locations with a double walled barrier. The double wall barrier includes two masses (e.g., two walls) that are separated by a cavity filled with air. This solution is generally superior to the mass solution stated above, but the presence of air in the cavity acts as a medium for the transmission of sound between the two masses. Accordingly, this solution still permits more sound to pass from one location to another than is desired.

Another solution entails separating compartments or adjacent locations with a double wall barrier having a cavity disposed between the two walls and a vacuum within the cavity. This solution is superior to the double walled solution discussed above because the absence of any matter between the two walls inhibits the transmission of any sound energy from one wall to the other. However, the long-term maintenance of a vacuum poses a challenge. When the vacuum fails, this solution provides no greater sound isolation than the solution discussed above. Furthermore, in order to maintain a vacuum between the two walls, a rigid, robust structure must be employed to support the two walls in a spaced apart relationship. The rigidity of the structure may substantially limit the locations where it may be employed. Additionally, because of the strength and robust nature of the materials used in the support frame that connects the two walls, the frame itself may transmit vibration from the acoustically or vibrationally excited source wall to the receiver wall that will then radiate sound to the receiver space. The rigid structure connecting the two walls can become a vibration flanking path.

Another solution is to use an acoustic barrier assembly utilizing a lighter-than-air gas insulator. In an embodiment, an acoustic barrier assembly comprises a flexible container defining a fluid-tight pocket in which a lighter-than-air gas is housed. The lighter-than-air gas serves as an excellent sound barrier.

However, if the acoustic barrier assembly is constructed from a flexible material or fabric, then there is a risk that the acoustic barrier assembly may deform spherically (i.e., balloon out to form the shape of a ball) if there is a decrease in the ambient air pressure. This deformation could potentially leave open pockets that had been filled prior to the change in air pressure. These pockets would naturally fill with air and thus would constitute a pathway for sound. This is undesirable.

Alternatively, if the acoustic barrier assembly is constructed with inflexible walls to prevent spherical deformation, then there is a risk that the lighter-than-air gas may not remain equally distributed between the walls. Rather, it may partially vacate one end of the acoustic barrier assembly and collect at the opposite end. This could happen if the inflexible walls are exposed to unevenly distributed external forces. This could cause the walls to collapse towards one another at one end of the acoustic barrier assembly and to spread apart at the opposite end, yielding an acoustic barrier assembly having a diminished capacity to block sound uniformly. This is also undesirable.

Accordingly, it is desirable to provide an acoustic barrier assembly that addresses the concerns expressed above. It is also desirable to provide a method of manufacturing an aircraft using an acoustic barrier assembly that addresses the concerns expressed above. Furthermore, other desirable features and characteristics will become apparent from the subsequent summary and detailed description and the appended claims, taken in conjunction with the accompanying drawings and the foregoing technical field and background.

### BRIEF SUMMARY

Various embodiments of an acoustic barrier assembly are disclosed herein.

In a first non-limiting embodiment, the acoustic barrier assembly includes, but is not limited to, a first wall that is gas impermeable. The acoustic barrier assembly further includes, but is not limited to, a second wall that is gas impermeable. The second wall is disposed opposite the first wall. The acoustic barrier assembly further includes, but is not limited to, a periphery wall coupling the first wall with the second wall in a manner that forms a pocket between the first wall and the second wall. The periphery wall is flexible and the pocket is fluid-tight. The acoustic barrier assembly further includes, but is not limited to, a gas disposed in the pocket. The gas has a first molecular weight that is lower than a second molecular weight of air. The acoustic barrier assembly still further includes, but is not limited to, a biasing member that is disposed within the pocket. The biasing member is coupled with both the first wall and the second wall.

In another non-limiting embodiment, the acoustic barrier assembly includes, but is not limited to, a first wall that gas impermeable and that is flexible. The acoustic barrier assembly further includes, but is not limited to, a second wall that is gas impermeable. The second wall is disposed opposite the first wall. The acoustic barrier assembly further includes, but is not limited to, a periphery wall coupling the first wall with the second wall in a manner that forms a pocket between the first wall and the second wall. The periphery wall is flexible and the pocket is fluid-tight. The acoustic barrier assembly further includes, but is not limited to, a gas disposed in the pocket. The gas having a first molecular weight that is lower than a second molecular weight of air. The acoustic barrier assembly still further includes, but is not limited to, an elastic member that is disposed within the pocket. The elastic member is coupled with both the first wall and the second wall and is configured to restrain the first wall and the second wall in a manner that inhibits the first wall and the second wall from ballooning spherically in an outward direction.

In another non-limiting embodiment, the acoustic barrier assembly includes, but is not limited to, a first wall that is gas impermeable and that is inflexible. The acoustic barrier assembly further includes, but is not limited to, a second wall that is gas impermeable and that is inflexible. The second wall is disposed opposite the first wall. The acoustic barrier assembly further includes, but is not limited to, a periphery wall coupling the first wall with the second wall in a manner that forms a pocket between the first wall and the second wall. The periphery wall is flexible and the pocket is fluid-tight. The acoustic barrier assembly further includes, but is not limited to, a gas disposed in the pocket. The gas has a first molecular weight that is lower than a second molecular weight of air. The acoustic barrier assembly still further includes, but is not limited to, a spring disposed within the pocket. The spring is coupled with both the first wall and the second wall and is configured to restrain the first wall and the second wall in a manner that inhibits the first wall and the second wall approaching one another beyond a predetermined distance.

### BRIEF DESCRIPTION OF THE DRAWINGS

The present invention will hereinafter be described in conjunction with the following drawing figures, wherein like numerals denote like elements, and

FIG. 1 is a fragmentary schematic cross-sectional view of an aircraft suitable for use with embodiments of an acoustic barrier assembly of the present disclosure;

FIG. 2 is a schematic fragmentary cross-sectional view of an exemplary dividing structure (such as a wall, floor, door, fuselage, etc.) of the aircraft of FIG. 1 suitable for housing the acoustic barrier assembly of the present disclosure;

FIG. 3 is a perspective view illustrating a non-limiting embodiment of the acoustic barrier assembly of the present disclosure;

FIG. 4A is a schematic cross-sectional view of a non-limiting embodiment of an acoustic barrier assembly of the present disclosure;

FIGS. 4B-C are schematic cross-sectional views of alternate embodiments of the acoustic barrier assembly illustrated in FIG. 4A;

FIG. 5 is a schematic cross-sectional view of an alternate, non-limiting embodiment of an acoustic barrier assembly of the present disclosure;

FIG. 6A-D are schematic cross-sectional views illustrating alternate configurations of the acoustic barrier assembly of FIG. 5;

FIG. 7 is a top view of the acoustic barrier assembly of FIG. 5;

FIG. 8 is a flow diagram illustrating a non-limiting embodiment of a method of manufacturing a vehicle in accordance with the teachings disclosed herein;

FIG. 9 is a perspective view illustrating another non-limiting embodiment of an acoustic barrier assembly made in accordance with the teachings of the present disclosure;

FIG. 10 is a cross sectional view taken along the line 10-10 of FIG. 9;

FIG. 11 is a transparent view illustrating the acoustic barrier assembly of FIG. 9;

FIG. 12 is a perspective view illustrating another non-limiting embodiment of an acoustic assembly made in accordance with teaching of the present disclosure;

FIG. 13 is a schematic cross-sectional view illustrating a first alternate embodiment of the acoustic barrier assembly of FIG. 9;

FIG. 14 is a schematic cross-sectional view illustrating the first alternate embodiment illustrated in FIG. 13 at a different atmospheric pressure;

FIG. 15 is a schematic cross-sectional view illustrating a second alternate embodiment of the acoustic barrier assembly of FIG. 9;

FIG. 16 is a schematic cross-sectional view illustrating the second alternate embodiment of FIG. 15 as it encounters an unbalanced compressive force; and

FIG. 17 is a schematic cross-sectional view illustrating a third alternate embodiment of the acoustic barrier assembly of FIG. 9.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved acoustic barrier assembly is disclosed herein. In a non-limiting embodiment, the acoustic barrier assembly comprises a double wall structure that is configured to be positioned between the walls forming a bulkhead, the panels of a door, outer skin of a fuselage and cabin interior wall, and any other structure having a double wall configuration with hollow space situated therebetween. In other embodiments, the acoustic barrier assembly may be coupled with single wall structures. In still other embodiments, the acoustic barrier assembly may be employed in a stand-alone manner and need not be disposed between the two walls of a double wall structure or disposed adjacent a single wall structure.

In a non-limiting embodiment, the two walls forming the double wall structure of the acoustic barrier assembly are constructed of a gas impermeable material. As used herein, when referring to the materials used in the construction of the acoustic barrier assembly, the term “gas impermeable” means a material having the characteristic that lighter-than-air gases are physical precluded from passing completely through the material. In some embodiments, the gas impermeable material may be elastic while in other embodiments, the gas impermeable material may be substantially inelastic. In some embodiments, the gas impermeable material may be resistant to punctures. The two walls are positioned opposite one another and are coupled together such that a pocket is formed between the two walls. The coupling together of the two walls may be accomplished by sealing portions of the two walls to one another with an epoxy or other adhesive, by thermo-sealing (e.g., melting) the two walls together, by welding two flexible walls together, by one or more fasteners such as a clamp, by combinations of any of the foregoing, or by joining the two walls together in any other manner that yields a suitable fluid-tight seal. In an embodiment where the side walls of the acoustic barrier assembly are constructed of flexible material, the walls are inherently vibrationally isolated from one another so added vibration isolators may not be necessary. In embodiments where the side walls of the acoustic barrier assembly are constructed of inflexible material, vibration isolation between the two walls may be needed.

In a non-limiting embodiment, a valve is coupled to the double wall structure such that the valve is placed in fluid communication with an interior portion of the pocket. The valve is configured to be selectively opened and closed. When the valve is opened, a gas can be introduced into the pocket or evacuated therefrom. When the valve is closed, the two walls and side walls forming the pocket cooperate with the valve to seal the pocket in a fluid tight manner.

In a non-limiting embodiment, the pocket contains a gas having a molecular weight lower than the molecular weight of air. For ease of reference, this gas may be referred to herein as a “lightweight” gas. In an embodiment, the lightweight gas may be helium. The lightweight gas may be introduced into the pocket via the valve. In an embodiment, the pocket will be evacuated prior to the introduction of the lightweight gas. In another embodiment, the pocket may not be evacuated prior to the introduction of the lightweight gas but rather the introduction of the lightweight gas may cause the displacement of the heavier gas occupying the pocket. When the pocket is filled with the lightweight gas, the acoustic barrier assembly will have a shape that is suitable to allow the acoustic barrier to be introduced into, and maintained within, the space between the two walls of the structure that is to be insulated (e.g., a bulkhead, a door).

In other embodiments, it may be preferable to position the acoustic barrier assembly between the two walls of the structure to be insulated prior to the introduction of the lightweight gas into the pocket of the acoustic barrier assembly and to then inflate the pocket with the lightweight gas once the acoustic barrier assembly is in a desired position. This ability to inflate the acoustic barrier assembly after it is situated in the location where it is needed may make the acoustic barrier assembly of the present disclosure ideally suited for use in cavities, crevices, and other spaces that are difficult to access or that are non-uniform in their cross-sectional dimensions.

With the acoustic barrier assembly positioned between the two walls of a structure, such as a bulkhead or a fuselage cavity, and also in arrangements where the acoustic barrier assembly is employed in a stand-alone manner as the only structure disposed between locations needing to be sound insulated from one another, the acoustic barrier assembly of the present disclosure will provide superior sound mitigation compared to the prior conventional methods described above in the Background section. This is because the acoustic barrier assembly of the present disclosure employs a lightweight gas. The use of a lightweight gas such as, but not limited to, helium will substantially diminish the ability of the acoustic barrier assembly to transmit sound energy between the two walls of the acoustic barrier assembly. By virtue of their lower mass, the gas molecules of the lightweight gas will be less capable of transmitting energy. By way of analogy, an acoustic barrier assembly filled with ping pong balls will inherently be less capable of transmitting vibrations between the two walls of the acoustic barrier assembly than would an acoustic barrier assembly filled with billiard balls. This same principle applies at the molecular level.

In another non-limiting embodiment, the acoustic barrier assembly does not include a valve. Rather, the acoustic barrier assembly is filled with the lighter-than-air gas and sealed. In such embodiments, the material used in the construction of the acoustic barrier assembly and manner in which the acoustic barrier assembly is constructed will prevent the lighter-than-air gas from seeping or leaking out of the pocket of the acoustic barrier assembly.

In another non-limiting embodiment, the acoustic barrier assembly will include a periphery wall. The periphery wall may comprise a separate component that has been coupled with the first wall and with the second wall in a manner that forms a fluid-tight pocket between the first wall and the second wall. In other embodiments, the periphery wall comprises a portion of the first wall and a portion of the second wall, such portions being coupled together to seal the fluid-tight pocket.

In another embodiment, the acoustic barrier assembly will include a biasing member disposed within the pocket. The biasing member is coupled with both the first wall and the second wall and is configured to help constrain movement of the first wall and the second wall towards and/or away from each other to facilitate maintenance of the overall shape and planform of the acoustic barrier assembly. For example, in embodiments where the first wall and/or the second wall are flexible, the biasing member will act in tension and inhibit the acoustic barrier assembly from spherically inflating. In embodiments where the first wall and the second wall are inflexible, the biasing member will act in compression and ensure that a portion of one of the walls does not collapse onto the other wall. The biasing member may also be employed in tension when both walls are inflexible to ensure that the periphery wall does not become taut. If the periphery wall were to become taut, it could potentially transmit vibrations between the two inflexible walls. This is undesirable. In some embodiments, a plurality of the biasing members may be employed.

As used herein with reference to the walls of the acoustic barrier assembly, the term “flexible” and “inflexible” are defined in terms of the deflection of the wall when the wall encounters a pressure differential between opposite sides of the wall (i.e., a greater pressure acting on one side of the wall than the other). In a non-limiting embodiment, the term “flexible” shall mean that a wall shall deflect by an amount equal to or greater than two percent of the longest length of the wall when the wall is subjected to a maximum anticipated pressure differential. In other embodiments, the specified percentage limitation may be three percent. In other embodiments, the specified percentage may be four percent. In still other embodiments, the specified percentage may be five percent. Furthermore, as used herein with reference to the walls of the acoustic barrier assembly, the term “inflexible” shall mean that a wall shall deflect by an amount less than two percent of the longest length of the wall when the wall is subjected to a maximum anticipated pressure differential on one side of the wall. In other embodiments, the specified percentage limitation may be three percent. In other embodiments, the specified percentage may be four percent. In still other embodiments, the specified percentage may be five percent. As used herein, the term “maximum anticipated pressure differential” shall mean the pressure differential that the wall encounters during standard operating conditions. For example, in the case of an aircraft, the maximum anticipated pressure differential refers to the difference between the static pressure inside of the acoustic barrier assembly and the ambient atmospheric pressure outside of the acoustic barrier assembly when the aircraft in which the acoustic barrier assembly is mounted is flown at the design cruising altitude of the aircraft.

A greater understanding of the acoustic barrier assembly discussed above and a method of manufacturing a vehicle using the acoustic barrier assembly discussed above may be obtained through a review of the illustrations accompanying this application together with a review of the detailed description that follows.

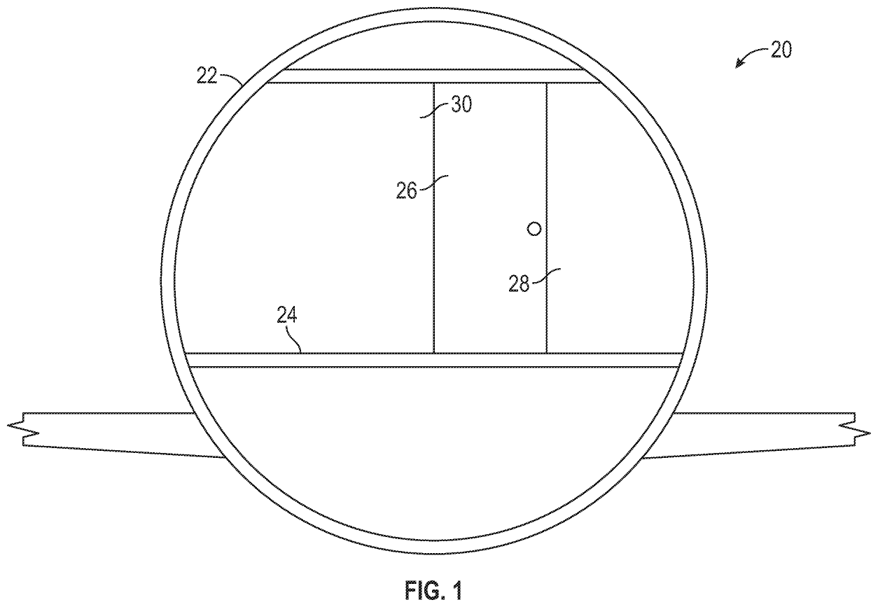

FIG. 1 is a fragmentary schematic cross-sectional view illustrating an aircraft 20. Aircraft 20 may comprise any type of aircraft including, without limitation, a subsonic aircraft, a supersonic aircraft, a propeller driven aircraft, a jet powered aircraft, a commercial airliner, a private business jet, a cargo aircraft, a military aircraft, and any other type of aircraft in which it is desirable to provide sound isolation. Additionally, although the acoustic barrier assembly of the present disclosure is being described and explained in the context of its application onboard an aircraft, it should be understood that the acoustic barrier assembly of the present disclosure is not limited to use onboard an aircraft. Rather, the acoustic barrier assembly of the present disclosure may be used in any type of vehicle including, but not limited to, automotive vehicles, surface and sub-surface watercraft, and spacecraft. Furthermore, the acoustic barrier assembly of the present disclosure is not limited to use in vehicles but may also be employed in other applications unrelated to vehicles such as, and without limitation, in the construction industry (e.g., building sound isolation into the walls of an apartment building) and in the furniture industry (e.g., building sound isolation into the partitions of office cubicles). In still other applications, the acoustic barrier assembly of the present disclosure may be employed in any industry and/or application where it is desirable to provide sound isolation.

Aircraft 20 includes a fuselage 22, a floor 24, a door 26, a bulkhead 28 and a bulkhead 30. In an exemplary embodiment, fuselage 22 separates occupants of aircraft 20 from the freestream air passing over and around aircraft 20 during flight. In an exemplary embodiment, floor 24 separates occupants of aircraft 20 from aircraft machinery such as landing gear, weapon systems, cargo, and avionics systems (not shown). In an exemplary embodiment, door 26, bulkhead 28, and bulkhead 30 cooperate to separate aircraft crew personnel from aircraft passengers. In each example given above, there is a partition that separates aircraft occupants from a source of sound (e.g., the freestream air, aircraft machinery, and other aircraft occupants, respectively). The partition may be constructed as a double wall or single wall.

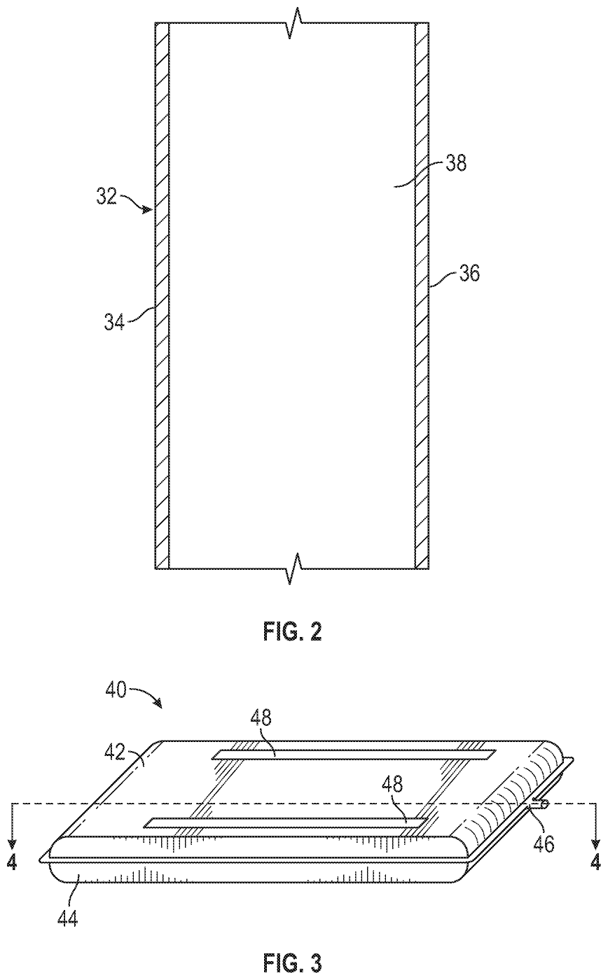

With continuing reference to FIG. 1, FIG. 2 is a fragmentary schematic cross-sectional view illustrating a partition 32. Partition 32 is an exemplary double wall constructed partition and may be suitable for use in the construction of fuselage 22, floor 24, door 26, and bulkheads 28 and 30. As illustrated, partition 32 includes a first wall 34, a second wall 36, and a cavity 38 disposed between first wall 34 and second wall 36. Cavity 38 is filled with air. If cavity 38 were to remain filled with air, then partition 32 would provide sound isolation commensurate with the level of sound isolation discussed in the Background section, above. This may be insufficient for situations that aircraft 20 is likely to encounter. Accordingly, it is desirable to position an acoustic barrier in cavity 38 to enhance the ability of partition 32 to inhibit the transmission of sound energy across partition 32.

In some embodiments, cavity 38 may have a three-dimensional rectangular configuration. Accordingly, it would be desirable to insert an acoustic barrier into cavity 38 that also has a three-dimensional rectangular configuration. In other embodiments, cavity 38 may have other three-dimensional configurations.

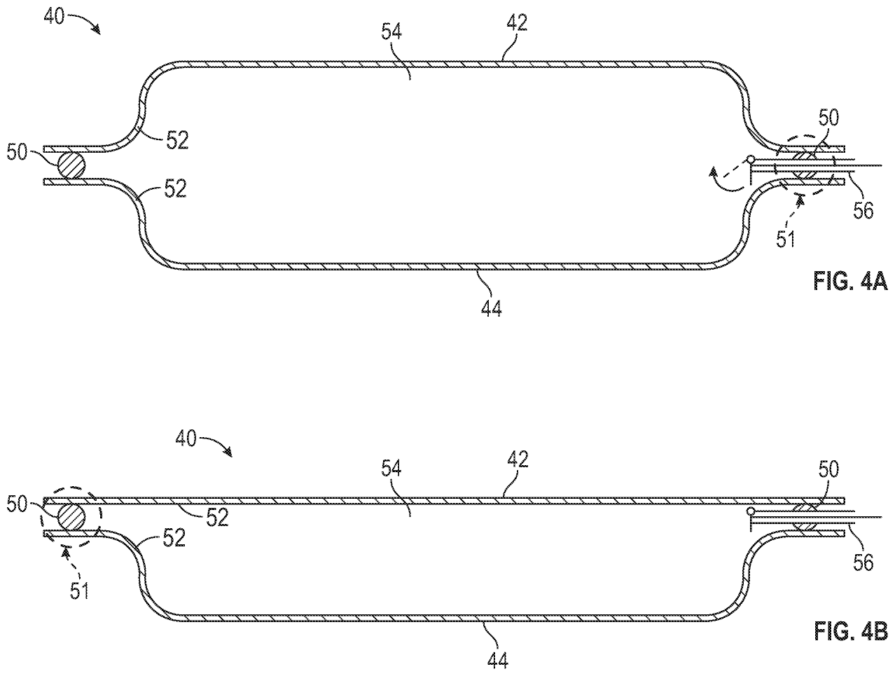

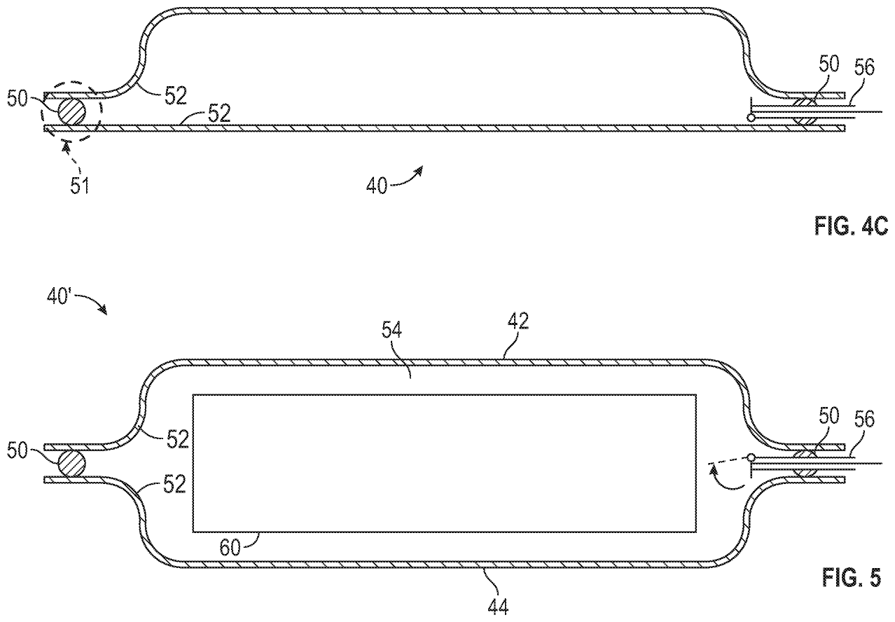

With continuing reference to FIGS. 1-2, FIG. 3 is a perspective view of a non-limiting embodiment of an acoustic barrier assembly 40. As illustrated, acoustic barrier assembly 40 has a generally three-dimensional rectangular configuration suitable for insertion into cavity 38. It should be understood that in other embodiments, acoustic barrier assembly 40 may have any other suitable shape and/or configuration that permits insertion into cavities having three-dimensional shapes other than a three-dimensional rectangular configuration. Acoustic barrier assembly 40 includes an upper wall 42 and a lower wall 44 coupled together forming a pocket therebetween (as best seen in FIGS. 4, 5, and 6A-D). A valve 46 provides fluid communication with the pocket and permits the introduction of gas into, and the extraction of gas from, the pocket. Acoustic barrier assembly 40 further includes a pair of coupling members 48 positioned along an upper surface (from the perspective of FIG. 3) of upper wall 42. In a non-limiting embodiment, pair of coupling members 48 may comprise double sided tape or a pair of hook-and-loop connectors (commonly known as Velcro™). In other embodiments, pair of coupling members 48 may alternatively be positioned along lower wall 44 while in still other embodiments, pair of coupling members 48 may be positioned along both upper wall 42 and lower wall 44.

With continuing reference to FIGS. 1-3, FIG. 4A is a schematic cross-sectional view of acoustic barrier assembly 40 taken along the line 4-4 of FIG. 3. For the sake of simplification, not every feature of acoustic barrier assembly 40 has been included in FIG. 4A. For example, pair of coupling members 48 have been omitted.

Upper wall 42 and lower wall 44 are each comprised of a material that is gas impermeable. Suitable materials for use in the construction of upper wall 42 and lower wall 44 include (collectively referred to herein as, the “walls”), but are not limited to, mono and composite layer films such as metallized polyester films, foils, or other substrates and elastomer coatings and specialty coated membrane films. In some embodiments, it may be desirable for the walls to be fabricated from a stiff material such as metal to facilitate the insertion of acoustic barrier assembly 40 into cavity 38. In other embodiments, it may be desirable for the walls to be fabricated from a more flexible material that permits the acoustic barrier assembly to be rolled up and inserted into cavity 38 and then unrolled once in place. In a non-limiting embodiment, upper wall 42 and lower wall 44 may be constructed of the same material. In other embodiments, upper wall 42 and lower wall 44 may be constructed of different materials.

As illustrated in FIG. 4A, upper wall 42 and lower wall 44 are coupled together by a mechanical coupling means 50. The ends of upper wall 42 and lower wall 44 and mechanical coupling means 50, together, form a seam 51. In the embodiment illustrated in FIG. 4A, seam 51 is centered between walls 42 and 44. It should be understood that in other embodiments, seam 51 may be disposed elsewhere on acoustic barrier 40. For example, in FIG. 4B, seam 51 is disposed at an upper end of acoustic barrier assembly 40 while in FIG. 4C, seam 51 is disposed at a lower end of acoustic barrier assembly 40. In other embodiments, seam 51 may be disposed at any suitable location on acoustic barrier assembly 40 without departing from the teachings of the present disclosure.

Mechanical coupling means 50 may comprise a bead of adhesive applied along substantially an entire periphery of upper wall 42 and lower wall 44. In other embodiments, mechanical coupling means 50 may comprise a thermo-coupling wherein the material comprising upper wall 42 and the material comprising lower wall 44 are melted together. In other embodiments, mechanical coupling means 50 may be a joint composed of a welding material that is heat coupled to both upper wall 42 and lower wall 44. In other embodiments, mechanical coupling means 50 may comprise a clamp or a series of clamps that extend along an entire perimeter of acoustic barrier assembly. In still other embodiments, any other means, method, mechanism, and/or combination thereof for coupling upper wall 42 and lower wall 44 together in a manner that provides for a fluid-tight coupling between upper wall 42 and lower wall 44 may be employed without departing from the teachings of the present disclosure.

With continuing reference to FIG. 4A, a pocket 52 is formed by upper wall 42 and lower wall 44. Pocket 52 is configured to contain a gas. A gas 54 is disposed within pocket 52. Gas 54 has a molecular weight lower than the molecular weight of air. Air has a weight of approximately 28 grams per mole. Accordingly, gas 54 has a molecular weight of less than 28 grams per mole. In one example, gas 54 is helium, having a weight of 4 grams per mole. In other examples, gas 54 may comprise any other gas having a mass per mole of less than 28 grams per mole.

A valve 56 extends through mechanical coupling means 50 and is fluidly coupled with pocket 52. Valve 56 permits gas 54 to be introduced into, and evacuated from, pocket 52. When valve 56 is closed (as illustrated in solid lines), it cooperates with upper wall 42, lower wall 44, and mechanical coupling means 50 to provide a fluid-tight container for gas 54. When valve 56 is opened (as illustrated in hidden lines), valve 56 permits the introduction or evacuation of gas 54 into and from, respectively, pocket 52. Valve 56 permits a construction worker or a maintenance worker to adjust the amount of gas 54 in pocket 52, as needed.

The size/dimensions of pocket 52 will expand and contract depending upon a number of factors including, but not limited to, the amount of gas disposed in pocket 52, the energy level of that gas, and the ambient atmospheric pressure outside of pocket 52. Accordingly, for a given number of gas molecules contained within pocket 52, the size/dimensions of pocket 52 may enlarge as the gas warms, it may diminish as the gas cools, it may enlarge as the ambient atmospheric pressure decreases, and it may diminish as the atmospheric pressure increases. The effects of changing atmospheric pressures and changing temperatures can be additive with one another in their impact on the size/dimensions of pocket 52 or they can offset one another in the impact they have on the size/dimensions of pocket 52. Familiarity with these factors can be helpful in tailoring acoustic barrier assembly 40 to fit snugly and/or loosely (as desired) within an allotted space in cavity 38 and/or to fit snugly or loosely (as desired) within cavity 38 when aircraft 20 is operating at a design altitude. For example, if it is desired that acoustic barrier assembly 40 fit snugly in cavity 38 between first wall 34 and second wall 36, and if it is known that aircraft 20 is designed to operate at an altitude of 50,000 feet, then both the temperature and ambient atmospheric pressure that acoustic barrier assembly 40 will encounter during aircraft operations are known. With a knowledge of the volume of space available in cavity 38 and in pocket 52 and with an understanding of the behavior of gas 54 under known temperature and pressure conditions, then an amount of gas 54 can be introduced into pocket 52 that will permit acoustic barrier assembly 40 to snugly fit within cavity 38 between first wall 34 and second wall 36.

With continuing reference to FIGS. 1-4, FIG. 5 is a schematic cross-sectional view illustrating an alternate embodiment of an acoustic barrier assembly 40′. Acoustic barrier assembly 40′ is substantially similar to acoustic barrier assembly 40. The primary difference between acoustic barrier assembly 40 and acoustic barrier assembly 40′ is that acoustic barrier assembly 40′ includes a body 60 disposed in pocket 52. Body 60 is configured to fit entirely within pocket 52 and to give acoustic barrier assembly 40′ its overall shape and to retain that overall shape regardless of whether gas 54 occupies pocket 52. In some embodiments, body 60 may be comprised of sub-bodies that may be arranged in an aligned manner to form a segmented body 60. In such embodiments, each sub-body may be positioned in direct contact with each adjacent sub-body to form body 60. In other embodiments, the sub-bodies may be spaced apart from one another such that some or all of the sub-bodies avoid direct contact with their neighboring sub-bodies. In other words, pocket 52 may contain a plurality of bodies 60. The use of multiple sub-bodies or the use of a plurality of bodies 60 provides for the opportunity to use different materials having different properties in a single acoustic barrier assembly 40′. It also provides for the opportunity to position acoustic barrier assembly 40′ inside of body cavities that are not planar in configuration, but which may have curvatures or bends or other non-linear spaces.

Body 60 may comprise any suitable material. In some embodiments, body 60 may comprise a sound absorbing material and thus may enhance the overall ability of acoustic barrier assembly 40′ to obstruct, inhibit, and/or absorb the transmission of sound between upper wall 42 and lower wall 44. Body 60 may be comprised of any suitable material, including, but not limited to, sound absorbing foam or fiber batting, and/or a limp mass barrier blanket. Foams may comprise open cell foams or partially open cell foams. Fiber batting may comprise fiberglass batting. Body 60 may also be constructed of fibrous blanket materials. Other suitable materials may also be employed without departing from the teachings of the present disclosure.

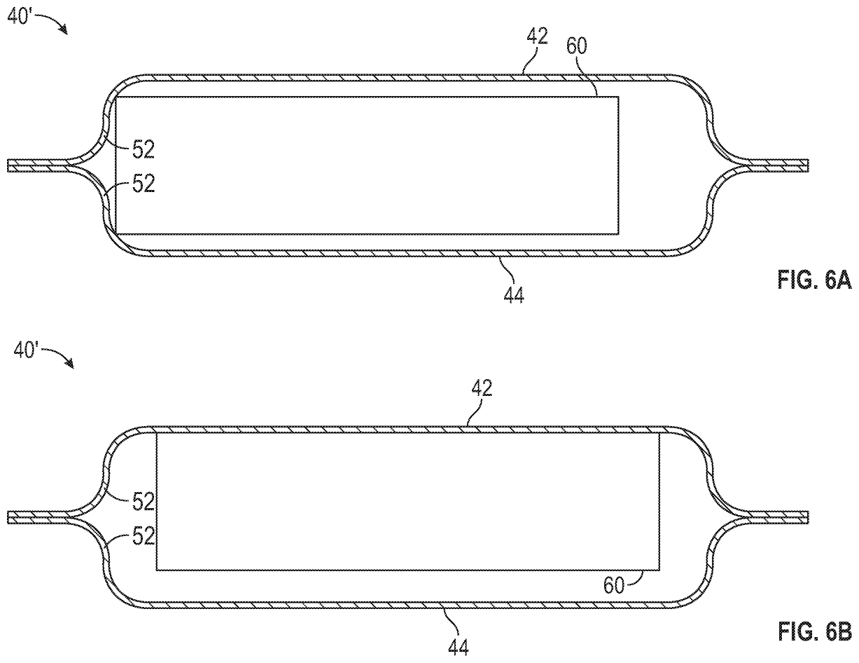

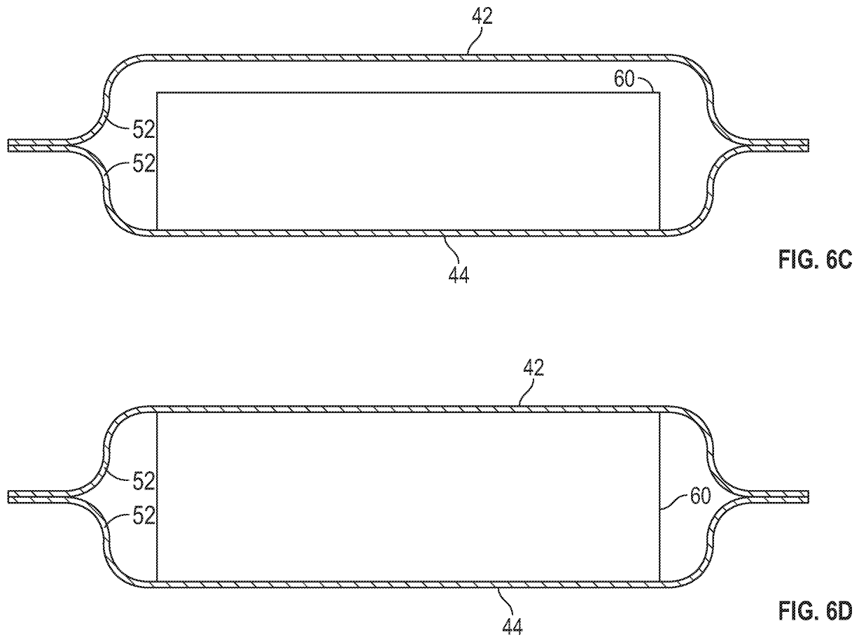

In FIG. 5, body 60 is depicted as floating freely within pocket 52, untethered to any interior surface of pocket 52. Accordingly, it should be understood that FIG. 5 illustrates a notional embodiment of acoustic barrier 40′. In practice, body 60 may be attached to one or more interior surfaces of pocket 52. Several such configurations are depicted in FIGS. 6A through 6D. In FIG. 6A, body 60 is secured to a left side portion of pocket 52 (e.g., a left side portion of upper wall 42 and lower wall 44) and is otherwise unsecured within pocket 52. In FIG. 6B, body 60 is secured to an upper surface of pocket 52 (e.g., a downward facing side of upper wall 42) and is otherwise unsecured within pocket 52. In FIG. 6C, body 60 is secured to a lower surface of pocket 52 (e.g., an upward facing side of lower wall 44) and is otherwise unsecured within pocket 52. In FIG. 6D, body 60 is secured to both an upper and lower surface of pocket 52 (e.g., to both a downward facing side of upper wall 42 and an upward facing side of lower wall 44) and is otherwise unsecured within pocket 52.

To ensure that body 60 does not contribute to the transmission of sound between upper wall 42 and lower wall 44, it is desirable for body 60 to be constructed of a compliant material. In a non-limiting example, such material may have a spring rate of no greater than two hundred pounds per inch per square inch of material. With continuing reference to FIGS. 4A-C, FIGS. 6A-D depict seam 51 disposed at a central location between upper wall 42 and lower wall 44. It should be understood that, as illustrated in FIGS. 4B and 4C, seam 51 may be disposed elsewhere on the acoustic barrier assembly.

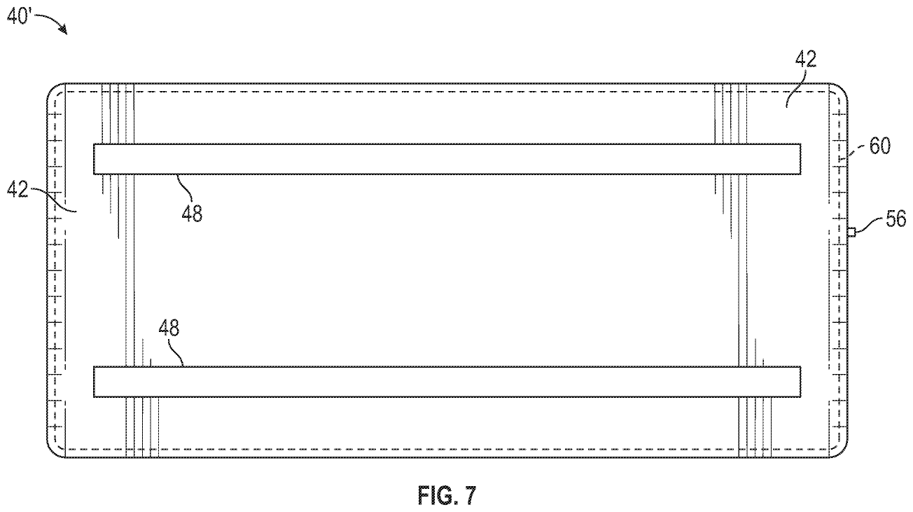

With continuing reference to FIGS. 1-6, FIG. 7 is a plan view of acoustic barrier assembly 40′. In FIG. 7, body 60 is illustrated in hidden lines. In this view, it can be seen that the overall shape and configuration of acoustic barrier assembly 40′ is provided by body 60. Body 60 serves as the skeletal structure for acoustic barrier 40′ while upper wall 42 and lower wall 44 serve as the skin. The structural rigidity imparted to acoustic barrier assembly 40′ by body 60 permits acoustic barrier assembly 40′ to be pushed into cavities.

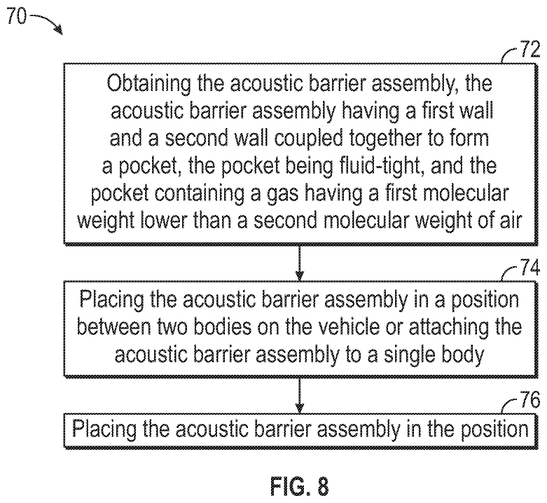

With continuing reference to FIGS. 1-7, FIG. 8 is a flow diagram illustrating the steps of a method 70 for manufacturing a vehicle with an acoustic barrier assembly. At step 72, an acoustic barrier assembly is obtained. The acoustic barrier assembly may have a first wall and a second wall coupled together to form a pocket. The pocket is fluid-tight meaning that it is configured to contain low molecular weight gas without leakage. The pocket further contains a gas. The gas has a molecular weight lighter than the molecular weight of air. In some embodiments, the acoustic barrier may comprise acoustic barrier assembly 40 or acoustic barrier assembly 40′, discussed above.

At step 74, the acoustic barrier is placed between two bodies on the vehicle. The two bodies are two bodies between which it is desired to provide sound isolation. In some examples, the two bodies may comprise the two walls of a double wall constructed door or bulkhead of an aircraft. In other examples, the two bodies may comprise the outer skin of a fuselage and the inner skin of a cabin. In still other embodiments, the two bodies may comprise any other structures between which it is desirable to provide sound isolation. In other embodiments, the acoustic barrier may be placed adjacent a single body without departing from the teachings of the present disclosure.

At step 76, the acoustic barrier assembly is affixed between the two bodies. In some embodiments, the acoustic barrier assembly may be affixed to one of the bodies while in other embodiments, the acoustic barrier assembly may be affixed to both bodies. In other embodiments employing single-walled construction, the acoustic barrier assembly may be affixed adjacent a single body. In some embodiments, the acoustic barrier assembly may be affixed using an adhesive, a tape, a hook-and-loop type fastener, a mechanical fastener, or any other means suitable to retain the acoustic barrier assembly in its position between the two bodies or adjacent the single body. In other embodiments, the acoustic barrier assembly may be held in place between the two bodies or on the single body by the features of those bodies without any additional means of fixation.

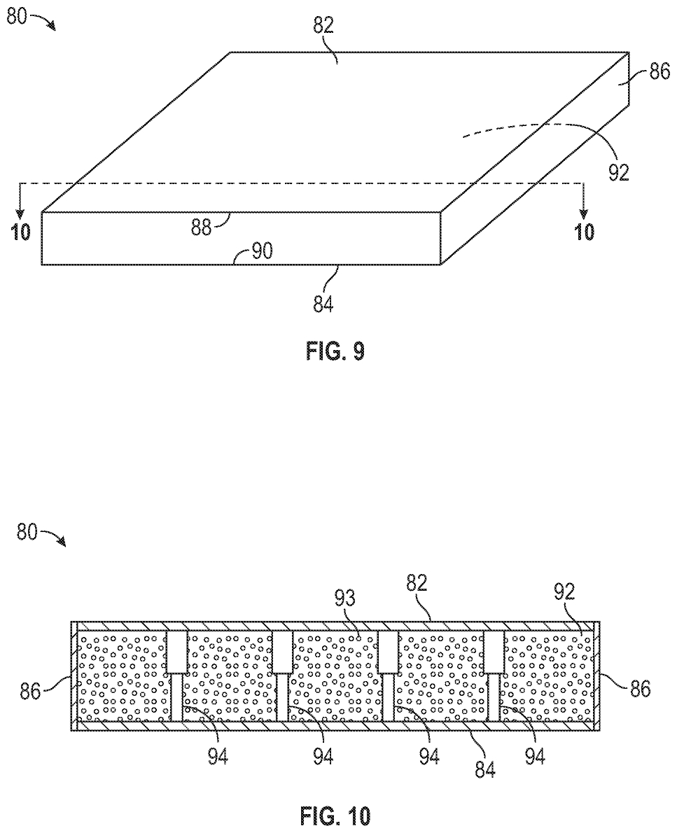

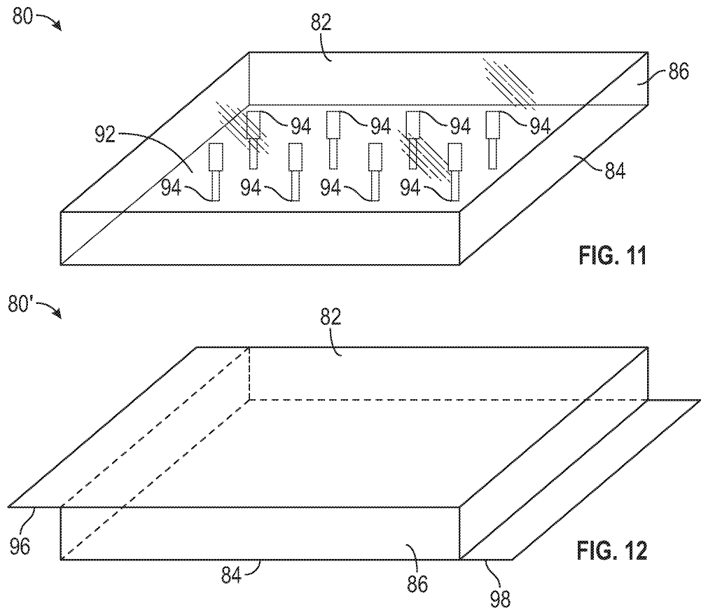

With respect to FIG. 9, a perspective view is presented illustrating another non-limiting embodiment of an acoustic barrier assembly 80 made in accordance with the teachings of the present disclosure. Acoustic barrier assembly 80 includes a wall 82 forming an upper surface of acoustic barrier assembly 80. Acoustic barrier assembly 80 further includes a wall 84 (best seen in FIGS. 10 and 11) forming a lower surface of acoustic barrier assembly 80. Wall 82 and wall 84 are each comprised of a gas impermeable material. Acoustic barrier assembly 80 further includes a periphery wall 86. Periphery wall 86 also comprises a gas impermeable material. In the illustrated embodiment, periphery wall 86 is coupled along a lateral edge 88 to a periphery of wall 82 and along an opposite lateral edge 90 to a periphery of wall 84. Opposite ends of periphery wall 86 are coupled with one another (not shown). The coupling of periphery wall 86 with wall 82 and wall 84 and the coupling of the longitudinal ends of periphery wall 86 to one another may be accomplished using any of the mechanisms and/or methods described above to provide a fluid-tight coupling. Arranged in this manner, walls 82 and 84, and periphery wall 86 cooperate to form a pocket 92. Because walls 82 and 84 and periphery wall 86 are each gas impermeable, and because periphery wall 86 is coupled with walls 82 and 84 via the gas-impermeable mechanisms and/or methods described above, pocket 92 comprises a fluid tight pocket that is able to contain a lighter-than-air gas.

With continuing reference to FIG. 1-9, FIG. 10 illustrates a cross-sectional view of acoustic barrier assembly 80 taken along line 10-10 of FIG. 9 and FIG. 11 illustrates a transparent view of acoustic barrier assembly 80. Accordingly, both FIGS. 10 and 11 provide a view of an interior portion of acoustic barrier assembly 80, including pocket 92.

As illustrated in FIG. 10, a lighter-than-air gas 93 is disposed within pocket 92. In some embodiments, lighter-than-air gas 93 may comprise helium. As discussed above, lighter-than-air gas 93 acts as an acoustic insulator and inhibits the transmission of sound and vibration from between walls 82 and 84. Lighter-than-air gas 93 further serves to occupy the space between walls 82 and 84. Because lighter-than-air gas 93 is a gas, it constantly exerts an outward pressure (i.e., static pressure) on an interior portion of walls 82 and 84, and on periphery wall 86, and thereby helps to keep walls 82 and 84 spaced apart from one another.

In some embodiments, acoustic barrier assembly 80 may be employed onboard an aircraft such as aircraft 20. While taxiing or parked, aircraft 20 will be in an environment where the ambient atmospheric pressure will be at or close to the atmospheric pressure at sea level. However, while in flight, the aircraft will be at an elevated altitude and will therefore be in an environment having an atmospheric pressure lower than that of sea level. Because acoustic barrier assembly 80 is sealed to contain lighter-than-air gas 93, acoustic barrier assembly 80 will expand and contract as lighter-than-air gas 93 expands and contracts in response to the changing atmospheric conditions. While the aircraft is on the ground, acoustic barrier assembly 80 will be in a relatively compact state due to the relatively high atmospheric pressure it encounters. However, while the aircraft is cruising at altitude, acoustic barrier assembly 80 will be in an expanded state due to the relatively low atmospheric pressure surrounding it. Accordingly, when employing acoustic barrier assembly 80 in the construction of a wall, door, or other structure that will be installed on a vehicle that will be subjected to changing atmospheric pressures, the spacing and positioning of one or more acoustic barrier assemblies 80 will need to be arranged in a manner that accommodates its changing volumetric requirements. In some embodiments, the goal may be to stack, arrange, and/or position acoustic barrier assemblies 80 in a manner such that, at the altitude of intended use, acoustic barrier assemblies 80 fill the space they are insulating and leave no gaps.

In a non-limiting embodiment, periphery wall 86 comprises a flexible material. In some non-limiting embodiments, the flexible material may be elastic while in other non-limiting embodiments, the flexible material may be inelastic. Therefore, depending upon the amount of lighter-than-air gas 93 that is disposed within pocket 92, periphery wall 86 may either have slack or it may be in tension. It is preferable for periphery wall 86 to be in a slack state to inhibit the transmission of sound energy or vibrations between walls 82 and 84. Accordingly, when filling pocket 92 with lighter-than-air gas 93, the different atmospheric pressures that acoustic barrier assembly 80 will be subjected should be considered. Accordingly, it is desirable to fill pocket 92 with an amount of lighter-than-air gas 93 that will avoid placing periphery wall 86 in tension when the vehicle reaches its design altitude. This can be calculated in a number of ways, including use of the hypsometric formula, as set forth below:

$$P = {{P}_{0} ( 1 - \frac{0.0065 h}{T + 0.0065 h + 273.15} )}^{5.287}$$

$$Where \text{:}$$

$${P}_{o} = Sea level pressure in hPa ( eg , 1013.25 hPa = 0 ft )$$

$$h = Altitude in meters ( eg , 6000 ft = 1828.7 m )$$

$$T = Cabin Temperature in Celsius ( eg , 72 F . = 22.22 C . )$$

Using the noted formula with an aircraft with a cabin temperature of 72 degrees Fahrenheit, and a cabin altitude pressure of 6,000 ft, the perceived pressure in the cabin of the aircraft would equate to approximately 11.9 psi. The differential pressure is 11.9 psi-14.7 psi, or −2.75 psi. Therefore, an acoustic barrier assembly designed for a cabin altitude of 6,000 ft would require approximately 11.9 psi of lighter than air gas inserted into the pocket under standard sea level ambient conditions to achieve the desired shape. This assumes that the mass inside the acoustic barrier assembly remains constant when the volume is vacuumed to 11.9 psi absolute pressure at sea level.

With continuing reference to FIGS. 10 and 11, each figure illustrates a plurality of biasing members 94 arranged within pocket 92. As discussed in detail below, biasing members 94 may be configured to apply tension to walls 82 and 84 to ensure that they do not move further apart from one another than desired. Alternatively, as discussed in detail below, biasing members 94 may be configured to apply an outwardly directed bias to walls 82 and 84 to oppose movement of one wall towards the other beyond a desired point. In still other embodiments, biasing members 94 may be configured to provide both inwardly and outwardly directed bias to ensure that walls 82 and 84 do not move further apart or close together than desired. Suitable biasing members and mechanisms include, but are not limited to, springs, elastic bands, rubber bands, foam bodies, hydraulic struts, pneumatic struts.

In the illustrated embodiment, there are a total of eight biasing members 94 depicted. However, it should be understood that a greater or smaller number of biasing members 94 may be employed without departing from the teachings of the present disclosure. For example, in some embodiments, a single biasing member may be sufficient to provide the desired bias to inhibit deformation of acoustic barrier assembly 80 beyond a predetermined limit. Additionally, while biasing members 94 have been depicted as being uniformly distributed throughout pocket 92, in other embodiments, it may be desirable to arrange biasing members 94 in a non-uniform manner. In some embodiments, it may be desirable to have a concentration of biasing members 94 near a center portion of acoustic barrier assembly 80 with few or none proximate to periphery wall 86. In other embodiments, it may be desirable to arrange biasing members 94 in close proximity to periphery wall 86 with few or none disposed near a center of acoustic barrier assembly 80.

In FIG. 10, periphery wall 86 is a separate component from wall 82 and from wall 84. It should be understood that in other embodiments, periphery wall 86 need not comprise a separate component, but instead may comprise a portion of wall 82 or a portion of wall 84 or a portion of both walls 82 and 84 without departing from the teachings of the present disclosure. In some embodiments, periphery wall 86 can act as a biasing member. In such embodiments, periphery wall 86 can act as the sole biasing member for acoustic barrier assembly 80 or it may act in combination with internal biasing members 94.

As discussed earlier with respect to FIGS. 1-8, acoustic barrier assembly 80 may also include a sound absorbing body (not shown) housed within pocket 92. For example, an open celled foam may be inserted in pocket 92 to assist with sound damping, to assist in the maintenance of the overall shape of acoustic barrier assembly 80, or both. Such an open cell foam may fill the volume of pocket 92 without being attached to any wall of acoustic barrier assembly 80. The low molecular weight gas may be inserted so that the walls compress the open cell foam at sea level. Then, when the aircraft reaches its operating altitude, the foam is allowed to expand to its natural uncompressed height (or it may remain slightly compressed) without the walls of acoustic barrier assembly 80 ballooning out. In some embodiments, a plurality of sound absorbing bodies may be disposed within pocket 92 and positioned between biasing members 94.

With continuing reference to FIGS. 1-11, FIG. 12 illustrates an alternate embodiment acoustic barrier 80′. Acoustic barrier 80′ is very similar to acoustic barrier 80. The primary difference between the two embodiments is that periphery wall 86 is coupled with only a portion of a periphery of wall 82 and coupled with only a portion of a periphery of wall 84. Coupled in this manner, an end portion of wall 82 forms a flap 96 and an end portion of wall 84 forms a flap 98. Flaps 96 and 98 can be used to couple multiple acoustic barrier assemblies 80 to one another. Such an arrangement may be necessary depending upon the application where acoustic barrier 80 is being employed. Such couplings can be accomplished via any of the methods and/or mechanisms described above, including via the use of removable attachment mechanisms such as, but not limited to, a hook and loop engagement mechanism.

With continuing reference to FIG. 12, in the illustrated embodiment, flaps 96 and 98 extend from opposite ends of acoustic barrier assembly 80′. It should be understood that other configurations are also possible. For example, and without limitation, flaps 96 and 98 can extend from the same end of acoustic barrier assembly 80′, from neighboring ends of acoustic barrier assembly 80′ from multiple ends of acoustic barrier assembly 80′ and from all ends of acoustic barrier assembly 80′ without departing from the teachings of the present disclosure.

With continuing reference to FIGS. 1-12, FIGS. 13 and 14 are schematic cross-sectional views illustrating another embodiment of the acoustic barrier assembly of the present disclosure—acoustic barrier assembly 100. Acoustic barrier assembly 100 has a wall 102, a wall 104, and a periphery wall 106 cooperating to enclose a pocket 108 in a fluid-tight manner in which a quantity of lighter-than-air gas is contained. Acoustic barrier assembly 100 further includes a plurality of biasing members 110. In the illustrated embodiment, biasing members 110 comprise elastic bands (e.g., rubber bands) that apply an inwardly directed force in the direction indicated by arrows 112. Walls 102 and 104 are comprised of a gas impermeable material that is flexible and/or elastic. The lighter-than-air gas will push against an internal surface of walls 102 and 104 and, in the absence of biasing members 110, would cause acoustic barrier assembly 100 to assume a spherical or quasi-spherical shape. The presence of biasing members 110 in pocket 108 oppose movement of walls 102 and 104 away from one another and hence counteract the tendency of the lighter-than-air gas to cause acoustic barrier assembly 100 to spherically deform.

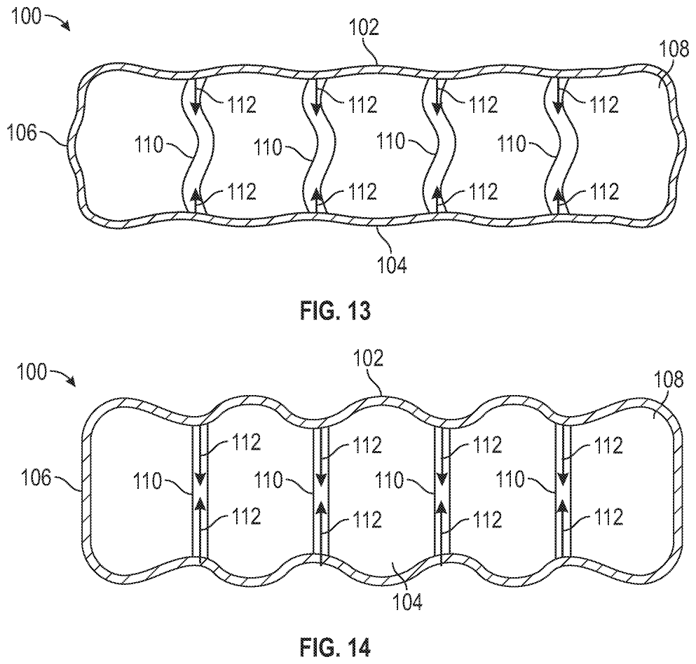

In FIG. 13, acoustic assembly 100 is located on an aircraft sitting at sea level. At sea level, acoustic assembly 100 encounters an atmospheric pressure of approximately 14.7 pounds per square inch. Acoustic barrier assembly 100 has been filled with a quantity of lighter-than-air gas that is intended to cause acoustic barrier assembly 100 to reach its expanded configuration (e.g., a configuration at which it will snugly fill the cavity on the aircraft that it was designed to fill) at a pressure altitude of four thousand feet, for example. Accordingly, at sea level, acoustic barrier assembly 100 encounters a relatively high atmospheric pressure and is therefore in a contracted state. At sea level, the atmospheric pressure is sufficient to contain the outward expansion of lighter-than-air gas in pocket 108 and the plurality of biasing members 110 are in a relatively relaxed or compressed state depending upon whether biasing members 110 are configured to pull or push, respectively, on walls 102 and 104. In this embodiment, the inner volume pressure will equalize to ambient pressure if pocket 108 is not restrained from collapsing in volume. The lighter-than-air gas in pocket 108 pushes, in a muted fashion, in an outward direction on walls 102 and 104. This can be discerned from the gentle curvature of the portions of wall 102 and wall 104 that are located between adjacent biasing members 110. While in the contracted configuration, there is an abundance of slack in periphery wall 106.

Acoustic barrier assembly 100 is still able to provide sound insulation while in a contracted state. However, because acoustic barrier assembly 100 may not extend across the entire interior of the cavity or because there may be gaps between acoustic barrier assembly 100 and the walls of its cavity or because there may be gaps between two adjacent acoustic barrier assemblies 100, there may be unobstructed pathways across which sound may travel. Accordingly, the overall effectiveness of acoustic barrier assembly 100 to insulate against sound will be reduced.

In FIG. 14, acoustic assembly 100 is located at an altitude of approximately 4,000 feet. At this altitude, the atmospheric pressure is about 12.7 pounds per square inch yielding a differential over the atmospheric pressure at sea level of about 2 pounds per square inch. In the face of this reduced atmospheric pressure, the lighter-than-air gas inside pocket 108 encounters less resistance from the atmosphere and it pushes wall 102 and wall 104 in an outward direction. Under these conditions, biasing members 110 exert a restraining force acting on acoustic barrier assembly 100 equal to the force exerted by the differential pressure between pocket 108 and the outside ambient air. Now, the lighter-than-air gas pushes more forcefully against the inner surface of walls 102 and 104 in an effort to expand outwardly until the inner and ambient forces acting on each wall are equalized. This outward expansion is prevented by biasing members 110. This can be observed by more severe curvature of the material of walls 102 and 104 located in between each biasing members 110, by the elongation of biasing members 110 and the corresponding increase in the arrows 112 indicating a greater tension in biasing members 110. Additionally, there is a reduction in the amount of slack present in periphery wall 106. The amount of lighter-than-air gas housed in pocket 108 has been calculated to ensure that periphery wall 106 does not become taut at the design altitude, otherwise periphery wall 106 may become a pathway for the transmission of sound energy and/or vibration.

With continuing reference to FIGS. 1-14, FIGS. 15 and 16 are schematic cross-sectional views illustrating another embodiment of the acoustic barrier assembly of the present disclosure—acoustic barrier assembly 120. Acoustic barrier assembly 120 has a wall 122, a wall 124, and a periphery wall 126 cooperating to enclose a pocket 127 in a fluid-tight manner in which a quantity of lighter-than-air gas is contained. Unlike acoustic barrier assembly 100 which had flexible walls 102 and 104, the walls of acoustic barrier assembly 120 (walls 122 and 124) are inflexible. Because walls 122 and 124 are inflexible, they inherently resist deformation and thus preclude acoustic barrier assembly 120 from spherically deforming under the urging of the lighter-than-air gas contained within pocket 127. The use of inflexible walls obviates the need to use elastic bands to prevent spherical deformation. However, inflexible walls will inherently have a heavier weight than flexible walls by virtue of the nature of the materials having flexible and inflexible qualities. This creates the possibility that one wall may approach or collapse towards the other under its own weight or in response to external compressive forces. The wall's inability to bend creates the possibility that one end of the wall may collapse towards the opposite wall while the opposite end of the collapsing wall is driven in the opposite direction away from the opposite wall. This lopsided compression/expansion can be exacerbated by the urging of the lighter-than-air gas that is driven from one end of acoustic barrier assembly 120 towards the other. This would give acoustic barrier assembly 120 a triangular or wedge-shaped cross-sectional profile and it would cause acoustic barrier assembly 120 to have a non-uniform distribution of the lighter-than-air gas in pocket 127. If unchecked, this could result in the narrow end of acoustic barrier assembly 120 having a diminished capacity to insulate against sound as compared with the wider end.

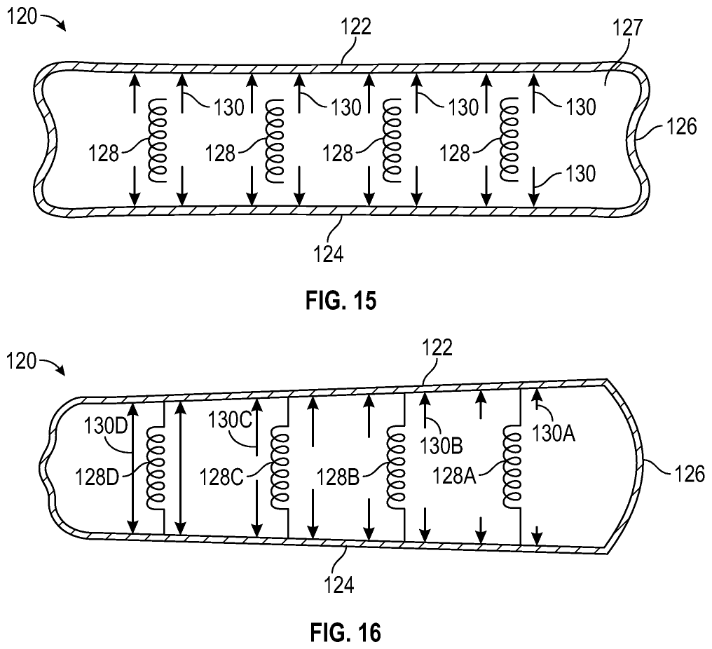

To address this concern, acoustic barrier assembly 120 includes a plurality of biasing members 128. In the illustrated embodiment, biasing members 128 comprise coil springs. In the embodiment illustrated in FIG. 15, biasing members 128 are each in a mild state of compression under the uniformly born weight of wall 122 and therefore each biasing member 128 is exerting a similar, mild, outwardly directed force (as indicated by arrows 130 all having approximately the same length) on walls 122 and 124. This outwardly directed force helps to keep walls 122 and 124 at a desired distance from one another and also helps to avoid uneven movement of one wall towards another. However, the biasing members are designed/chosen to have an appropriate spring constant and an appropriate dimension that avoids the application of an excessive amount of force to the walls. This maintains the opposite walls at a distance from one another that permits periphery wall 126 to remain in a relatively relaxed state of slack. Maintaining periphery wall 126 in a state of slack helps to avoid periphery wall 126 from becoming a pathway for the transmission of sound energy and vibration.

With continuing reference to FIGS. 1-15, FIG. 16 illustrates what would happen if one end of wall 122 were compressed towards or began to collapse under its own weight towards wall 124. As the left side of wall 122 (from the perspective illustrated in FIG. 16) moves towards the left side of wall 124, biasing members 128 act to prevent/mitigate the collapse. The load on the two biasing members 128 (biasing members 128A and 128B) on the right side of acoustic barrier assembly 120 is reduced as that end of wall 122 moves away from that end of wall 124. Consequently, the outward directed force exerted by biasing members 128A and 128B is reduced, as illustrated by the reduced length of the arrows 130A and 130B. This, in turn, curtails further the movement of the right side of wall 122 away from the right side of wall 124. In some embodiments, biasing members 128 may be selected such that movement of wall 122 away from wall 124 beyond a predetermined distance will place the biasing members in tension such that they would then actively oppose further outward movement of that portion of the walls. As the left side of wall 122 moves towards the left side of wall 124, the biasing members (biasing members 128C and 128D) on the left side of acoustic barrier assembly 120 are further compressed. This increases the amount of outward directed force exerted by biasing members 128C and 128D, as indicated by the increased length of arrows 130C and 130D. With a reduction in the outward force exerted on the right side of acoustic barrier assembly 120 and the contemporaneous increase in outward force being exerted on the left side of acoustic barrier assembly 120, the triangular or wedge-shaped configuration discussed above can be avoided or mitigated. The use of springs as a biasing member in this application inherently acts as a vibration isolating mechanism with respect to the transmission of vibrations between walls 122 and 124. Thus, despite the coupling of biasing members 110 to the inflexible walls 102 and 104, biasing members 110 will not serve as an efficient pathway for the transmission of vibration between walls 122 and 124.

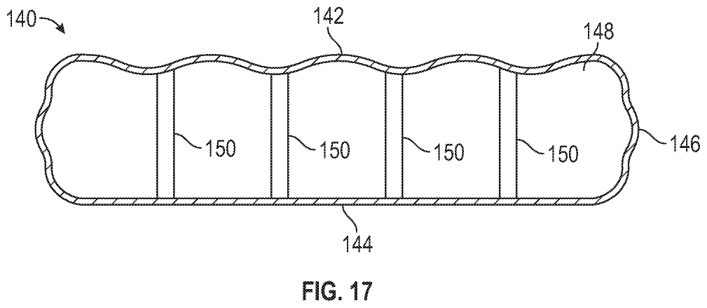

With continuing reference to FIGS. 1-16, FIG. 17 is a schematic cross-sectional view illustrating another embodiment of the acoustic barrier assembly of the present disclosure—acoustic barrier assembly 140. Acoustic barrier assembly 140 includes a wall 142, a wall 144, a periphery wall 146, a pocket 148, and biasing members 150. Unlike acoustic barrier assembly 100 in which both walls 102 and 104 were flexible, and unlike acoustic barrier assembly 120 in which both walls 122 and 124 were inflexible, in acoustic barrier assembly 140, wall 142 is flexible and wall 144 is inflexible. This allows acoustic barrier assembly 140 to be employed in unique or unconventional packaging spaces where acoustic barrier assemblies 100 and 120 may have limited efficacy. A rigid wall may be incorporated as a structural element for adjacent structures, for example, wall 144 could potentially be made of a gas impermeable honeycomb panel. Additionally, using one flexible wall instead of two inflexible walls may reduce the weight of the assembly. In some embodiments, rigid wall 144 could also be a single wall of the vehicle structure itself. Biasing members 150 may comprise any suitable type of biasing member necessary to prevent spherical deformation of acoustic barrier assembly 140 and to inhibit wall 144 from collapsing towards wall 142. Accordingly, in some embodiments, biasing members 150 may be able to exert both tension and compressive force.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. An acoustic barrier assembly comprising:
a first wall being gas impermeable;
a second wall being gas impermeable, the second wall disposed opposite the first wall;
a periphery wall coupling the first wall with the second wall in a manner that forms a pocket between the first wall and the second wall, the periphery wall being flexible and the pocket being fluid-tight;
a gas disposed in the pocket, the gas having a first molecular weight lower than a second molecular weight of air; and
a biasing member disposed within the pocket, the biasing member coupled with both the first wall and the second wall.

2. The acoustic barrier assembly of claim 1, wherein the first wall and the second wall are each rectilinear and have substantially equal dimensions.

3. The acoustic barrier assembly of claim 1, wherein the periphery wall is contiguous with a first periphery of the first wall and a second periphery of the second wall.

4. The acoustic barrier assembly of claim 1, wherein the periphery wall is contiguous with only a portion of a first periphery of the first wall and with only a portion of a second periphery of the second wall such that a first portion of the first wall overhangs the periphery wall to form a first overhang portion and wherein a second portion of the second wall overhangs the periphery wall to form a second overhang portion.

5. The acoustic barrier assembly of claim 4, wherein the first overhang portion and the second overhang portion are disposed on opposite ends of the acoustic barrier assembly.

6. The acoustic barrier assembly of claim 1, wherein the periphery wall comprises a portion of the first wall and a portion of the second wall.

7. An acoustic barrier assembly comprising:
a first wall being gas impermeable and being flexible;
a second wall being gas impermeable, the second wall disposed opposite the first wall;
a periphery wall coupling the first wall with the second wall in a manner that forms a pocket between the first wall and the second wall, the periphery wall being flexible and the pocket being fluid-tight;
a gas disposed in the pocket, the gas having a first molecular weight lower than a second molecular weight of air; and
an elastic member disposed within the pocket, the elastic member coupled with both the first wall and the second wall and configured to restrain the first wall and the second wall in a manner that inhibits the first wall and the second wall from ballooning spherically in an outward direction.

8. The acoustic barrier assembly of claim 7, wherein the second wall is flexible.

9. The acoustic barrier assembly of claim 7, wherein the second wall is inflexible.

10. The acoustic barrier assembly of claim 7, further comprising a plurality of the elastic members disposed within the pocket, each elastic member of the plurality of elastic members being spaced apart from one another and each elastic member being coupled with both the first wall and the second wall, wherein the plurality of elastic members cooperate to inhibit the first wall and the second wall from ballooning spherically in an outward direction.

11. The acoustic barrier assembly of claim 7, wherein the gas disposed in the pocket is in an amount that permits the periphery wall to have slack when the acoustic barrier assembly is disposed in an environment having a predetermined atmospheric pressure lower than an atmospheric pressure at sea level.

12. The acoustic barrier assembly of claim 11, wherein the predetermined atmospheric pressure is at least one pound per square inch below atmospheric pressure at sea level.

13. The acoustic barrier assembly of claim 7, wherein the periphery wall comprises an elastic material.

14. An acoustic barrier assembly comprising:
a first wall being gas impermeable and being inflexible;
a second wall being gas impermeable and being inflexible, the second wall disposed opposite the first wall;
a periphery wall coupling the first wall with the second wall in a manner that forms a pocket between the first wall and the second wall, the periphery wall being flexible and the pocket being fluid-tight;
a gas disposed in the pocket, the gas having a first molecular weight lower than a second molecular weight of air; and
a spring disposed within the pocket, the spring coupled with both the first wall and the second wall and configured to restrain the first wall and the second wall in a manner that inhibits the first wall and the second wall approaching one another beyond a predetermined distance at a predetermined maximum anticipated pressure differential.

15. The acoustic barrier assembly of claim 14, further comprising a plurality of the springs disposed within the pocket, each spring of the plurality of springs being spaced apart from one another and each spring being coupled with both the first wall and the second wall, wherein the plurality of springs cooperate to inhibit the first wall and the second wall from approaching one another beyond the predetermined distance.

16. The acoustic barrier assembly of claim 14, wherein the first wall and the second wall comprise one of a metal and a gas impermeable composite

17. The acoustic barrier assembly of claim 14, wherein the gas disposed in the pocket is in an amount that permits the periphery wall to have slack when the acoustic barrier assembly is disposed in an environment having a predetermined atmospheric pressure lower than an atmospheric pressure at sea level.

18. The acoustic barrier assembly of claim 17, wherein the predetermined atmospheric pressure is at least one pound per square inch below atmospheric pressure at sea level.

19. The acoustic barrier assembly of claim 14, wherein the periphery wall comprises an elastic material.

20. The acoustic barrier assembly of claim 14, wherein the periphery wall comprises the spring.
